(19) United States
(12) Patent Application Publication
(10) Pub. No.: US 2007/0281135 A1
(43) Pub. Date: Dec. 6, 2007

(54) Coated printing stock for use as labels and the like

(75) Inventors: Cecil M. Keeney, Metairie, LA (US); Bernard E. Pemberton, Rockville, MD (US); James D. Combs, Winchester, KY (US); David Enoch, Mt. Sterling, KY (US); Gregory L. Brown, Cadiz, KY (US)

Correspondence Address: KING & SCHICKLI, PLLC, 247 NORTH BROADWAY, LEXINGTON, KY, 40507, US

(73) Assignee: WALLE CORPORATION

(21) Appl. No.: 11/442,792

(22) Filed: May 30, 2006

(51) Int. Cl. B41M 5/00

(52) U.S. Cl. 428/195.1

(57) ABSTRACT

A label prepared from sheet printing stock includes a coating of an antistatic formulation over both exposed faces.

### TECHNICAL FIELD

The present invention relates generally to the product labeling and packaging fields and, more particularly, to a sheet of printing stock coated on both faces with an antistatic formulation.

### BACKGROUND OF THE INVENTION

Cut and stack labels have long been used on glass bottles, cans and plastic containers. Currently, there is a growing consumer preference for food, beverage and household products packaged in plastic containers. This is because plastic containers offer the consumer a number of convenient benefits including, but not limited to, portability, resealability, safety, light weight and contourability for a comfortable grip.

Plastic containers, however, pose several challenges for packaged goods companies and label manufacturers. One of the main reasons for this is that plastic containers are particularly durable and can withstand more demanding consumer environments, such as an ice chest, as well as withstand a drop to the ground of perhaps six feet or more. Further, a plastic container's portability means it can be used and the product consumed over a long period of time including days or weeks.

For label manufacturers, this means packaged goods companies prefer labels to be 100% waterproof, 100% scuff-proof, extremely durable, resistant to scuffing and product deterioration, able to withstand drops of six feet or more without tearing and be aesthetically pleasing to the consumer's eye and touch for the life of the use of the plastic container. Unfortunately, no state of the art label capable of use with existing cut and stack labeling equipment offers all of these desired performance features.

State of the art label solutions for plastic containers generally fall into four categories: poly/paper, aqueous coated synthetic, ultraviolet (UV) coated synthetic and poly/poly. An example of a state of the art poly/paper label is a lightweight clear polypropylene film laminated to C1S paper. The clear polypropylene film provides an attractive high gloss appearance. The film lamination also provides durability for scuff protection and passing drop tests. Due to its incorporation of a paper layer, however, the poly/paper label is not waterproof. Accordingly, when subjected to humid or wet environments, the label has a tendency to curl and/or to deteriorate.

An example of an aqueous coated synthetic label is a single layer heavyweight bright white polypropylene film that is aqueous coated. The 100% film nature of the construction provides the label with 100% waterproof properties. However, an aqueous coated synthetic label does not have the high gloss appearance or excellent scuff resistance properties of laminated labels and, accordingly, does not provide a complete answer to the needs of the packaged goods manufacturer.

An example of a UV coated synthetic label is a single layer of heavyweight bright white polypropylene film printing stock that is ultraviolet coated. Again, the 100% film nature of the construction provides the label with 100% waterproof properties. While the UV coated synthetic label does have a higher gloss appearance and improved scuff and product resistance properties when compared to an aqueous coated synthetic label due to the use of an ultraviolet coating, it does not offer the same degree of gloss and scuff protection as the film lamination label. This shortcoming along with the high cost of ultraviolet inks and coatings means that UV coated synthetic labels also fail to economically meet all the needs of the packaged goods manufacturer.

An example of a poly/poly label is a lightweight clear polypropylene film laminated to a lightweight white opaque polypropylene film printing stock. The clear polypropylene film provides an attractive high gloss appearance and excellent durability for scuff protection and passing drop tests. The 100% film nature of the construction provides the label with 100% waterproof properties. Poly/poly labels, produced in cut and stack form, have been dusted with an offset powder to prevent sticking and ensure proper feeding of the labels by the labeling equipment. Such an approach ensures smooth label feeding at high operating speeds and has been the industry standard for at least twenty years.

Unfortunately, such an approach has many significant drawbacks. More specifically, the powder is very fine and tends to become entrained in the air currents generated by the equipment during the printing, cutting and labeling operations. As a result, a dusting of fine offset powder settles on operating machines and all equipment. The powder penetrates the circuit boxes, clogs gas jets in dryers and represents a significant maintenance concern and expense. The label making equipment, electrical boxes and entire work area must be periodically cleaned. The offset powder also subjects label application equipment to the same maintenance concerns and needs.

The present invention relates to polymer labels coated on both faces with an antistatic formulation that prevents sticking and ensures proper label feeding in the absence of an offset powder. By eliminating the use of offset powder in the labeling process, equipment maintenance costs are greatly reduced and working conditions are greatly enhanced. In addition, the labels of the present invention offer an enhanced clarity of print in the absence of offset powder.

### SUMMARY OF THE INVENTION

In order to achieve the foregoing and in accordance with the purposes of the present invention as described herein, an improved label is provided comprising a sheet of printing stock having a first, printed face and a second opposite face and a coating of antistatic formulation over the first, printed face and the second, opposite face. Advantageously, the antistatic formulation effectively prevents labels from sticking together and thereby ensures that the labels are fed smoothly and properly even at the high labeling speeds favored by manufacturers. As a consequence, there is no need to dust the labels with an offset powder in order to obtain the desired characteristics. As noted above, labels devoid of offset powder provide a number of advantages respecting equipment maintenance, labeling efficiency and work environment.

The printing stock may be made from a material selected from a group consisting of a polymer film, polypropylene, polyethylene, polystyrene, vinyl, polyethylene terephthalate, polyester, cavitated white biaxially oriented polypropylene (BOPP), clear BOPP, saran polyethylene terephthalate, saran nylon cello, cello polypropylene, metalized polypropylene, cast polypropylene, metalized paper, metalized foil and mixtures thereof.

The antistatic formulation comprises in weight percent from about 2.0% to about 6.0% antistatic agent, from about 0% to about 3.0% slip agent/wax, from about 0% to about 0.3% defoamer and the remainder is solvent. The solvent is selected from a group consisting of alcohol, water and mixtures thereof. The antistatic formulation is applied to the first and/or second faces of the sheet of polymer film printing stock at a rate of one pound of antistatic formulation to between about 480,000 to about 900,000 square inches of surface area.

In accordance with an alternative embodiment, the label comprises a first sheet of printing stock having a first, printed face and a second, opposite face, a clear polymer film laminated to the first, printed face and a coating of antistatic formulation over the second, opposite face and an exposed face of the clear polymer film. Again, the antistatic formulation is applied at a rate of one pound of antistatic formulation to between about 480,000 to about 900,000 square inches of said first, printed face and the exposed face of said clear polymer film. Once again, the label may also be devoid of an offset powder. The printing stock and the antistatic formulation used in the second embodiment may be identical to those used in the first embodiment.

In still another label embodiment, the label comprises a first sheet of polymer film having a first face and a second face and a second sheet of clear polymer film having a printed face and an opposite face. The printed face of the clear polymer film is laminated to the first face and a coating of antistatic formulation is provided over the second face and the opposite, exposed face of the label. As with the first two embodiments this label may also be devoid of an offset powder. This label also includes polymer film printing stock and an antistatic formulation that may be identical to those of the first two embodiments.

In accordance with yet another aspect of the present invention, a packaging material is provided comprising a sheet of polymer film having a first face and a second face both coated with an antistatic formulation.

In accordance with yet another aspect of the present invention a method is provided for reducing maintenance costs associated with label handling equipment. That method comprises using labels coated on both faces with an antistatic formulation and devoid of offset powder.

In accordance with still another aspect of the present invention a method of producing labels from a web of printing stock comprises printing a first face of the printing stock and coating said first face and a second face of said printing stock with an antistatic formulation. The method further includes making a smooth feeding label without using an offset powder.

In addition, a method of producing labels from printing stock comprises printing a first face of said printing stock; laminating a clear polymer film to the first face of the printing stock over the printing and coating the two exposed faces of the label with an antistatic formulation.

Still further, a method of producing labels from a clear polymer film comprises printing a first face of the clear polymer film, laminating the first face of the clear polymer film to a face of a second layer of polymer film and coating the two exposed faces of the label with an antistatic formulation.

In the following description there is shown and described several preferred embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain certain principles of the invention.

FIG. 1 is a schematical edge elevational view of a first embodiment of a label constructed in accordance with the teachings of the present invention; and

FIG. 2 is an illustration similar to FIG. 1 but relating to an alternative embodiment.

Reference will now be made in detail to the present preferred embodiments of the invention, examples of which are illustrated in the accompanying drawings.

### DETAILED DESCRIPTION OF THE INVENTION

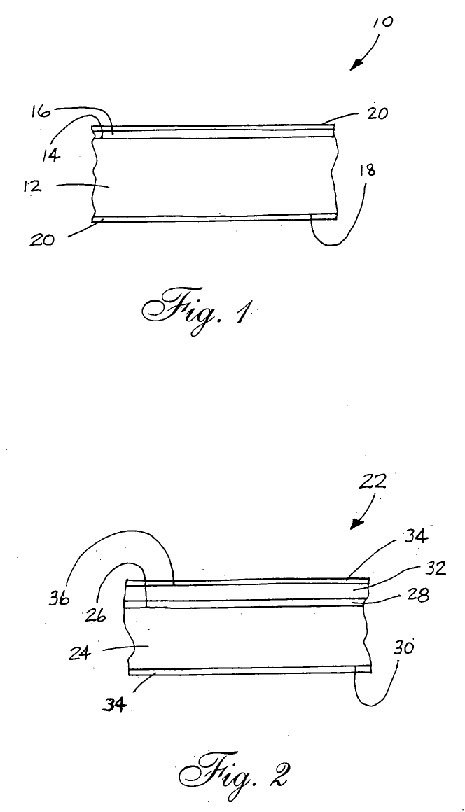

Reference is now made to drawing FIG. 1 clearly illustrating a first embodiment of the label 10 of the present invention. That label 10 comprises a sheet or layer of printing stock 12 having a first face 14 printed with ink or other appropriate material 16 and a second, opposite face 18. A coating 20 of an antistatic formulation is provided over both the first face 14, including the printing 16, and the second, opposite face 18.

A second possible embodiment of the present invention is illustrated in FIG. 2. The label 22 of this embodiment comprises a first layer or sheet of printing stock 24 having a first face 26 printed with an ink or other appropriate material 28. As shown the printing stock 24 also includes a second, opposite face 30. A clear polymer film 32 is laminated to the first, printed face 26 of the printing stock 24. A coating 34 of an antistatic formulation is provided over the face 30 and the exposed face 36 of the clear polymer film 32.

In yet another embodiment also shown in FIG. 2, instead of printing the first face 26 of the printing stock 24, a face of the clear polymer film 32 is printed with ink or other appropriate material 28. That printed face of the clear polymer film is then laminated to a second layer 24 of printing stock, polymer film or any appropriate label making material. The exposed faces 30 and 36 are coated with an antistatic formulation 34.

In any of the above embodiments, the printing stock 12 and 24 may be constructed from a material selected from a group consisting of polymer film, polypropylene, polyethylene, polystyrene, vinyl, polyethylene terephthalate, polyester, cavitated white BOPP (such as sold under the trademark AmTopp—PW or AmTopp—PL by Inteplast Group, LTD), clear BOPP (such as sold under the trademark AmTopp—TL by Inteplast Group, LTD), saran polyethylene terephthalate, saran nylon cello, cello polypropylene, metalized polypropylene, cast polypropylene, metalized paper, metalized foil and mixtures thereof. Preferably the printing stock 12 or 24 has a thickness of at least 0.5 mil and more typically between 0.5 mil-4.0 mil in order to provide the necessary stiffness to allow the label 10 or 22 to be used in existing labeling equipment. The printing stock 12 and/or 24 may be opaque, translucent or transparent. The printing stock 12 or 24 may be white, black or substantially any other color that might be desired by a product manufacturer or packager.

In order to produce the label 22 illustrated in FIG. 2, a clear drying adhesive is applied to the printed face 26 of the printing stock 24 and/or the back side of the clear polymer film 32 and the clear polymer film is laminated to the printing stock by the adhesive. One appropriate adhesive useful for this purpose is product number 14995, a UV laminating adhesive manufactured by Northwest Coatings of Oak Creek, Wis. Of course, other appropriate adhesives are well known in the art. Typically the adhesive is applied at the rate of one pound of adhesive per about 250,000 to about 450,000 sq in of surface area and more typically at a rate of about one pound of adhesive per 320,000 sq in of surface area.

The clear polymer film 32 may be made from any appropriate material including but not limited to polypropylene, polyethylene, polystyrene, polyvinyl chloride, polyethylene terephthalate, polytetrafluroethylene, polyvinyledene fluoride, polyvinyledene chloride, polyester, nylon and mixtures thereof. Typically the clear polymer film 32 is provided in a thickness of between about 0.5 mil-4.0 mil. Together, the polymer film printing stock 24 and the clear polymer film 32 are of a sufficient thickness and strength to provide the necessary stiffness to support application in existing labeling equipment. Additionally, the clear polymer film 32 provides the desired durability and scuff protection to protect the printing 28 on the face 26 of the printing stock 24 or the rear face of the clear polymer film 32 from damage during packaging, shipping, sale and use by the consumer.

The antistatic formulation used in the coatings 20 and 34 has a formulation comprising from about 2.0% to about 6.0% anti-static agent (e.g. ARMAK 1019, available from Akzo Nobel Surface Chemistry, LLC of Chicago, Ill.), 0-3.0% slip agent/wax (e.g. PBI-19559, available from Flint Ink of Atlanta, Ga.), 0-0.3% defoamer (e.g. Tego Foamex 1435, available from Tego Chemie Service GmbH of Essen, Germany) and the remainder is solvent. This solvent may be selected from a group consisting of water, alcohol and any mixture thereof. A typical alcohol utilized as a solvent in an antistatic formulation of the type being described is isopropyl alcohol. Typically the antistatic formulation is applied at a rate of one pound of antistatic formulation to between about 480,000 sq in to about 900,000 sq in of surface area and more typically at a rate of about one pound of antistatic formulation to about 598,000 sq in of surface area.

By coating both of the exposed faces of the label 10 or 22 with the antistatic formulation, the label is provided with sufficient lubricating and antistatic properties to allow ready separation of stacked labels in existing cut and stack labeling equipment. Specifically, the labels 10 and/or 22 have the necessary stiffness and antistatic properties to avoid sticking together and operate smoothly, efficiently and reliably in existing labeling equipment. Further the labels beneficially provide the properties desired by the packaged goods manufacturers utilizing plastic containers. The labels are 100% waterproof, extremely durable by being resistant to scuffing and product deterioration and able to withstand drops of six feet or more without tearing, and are aesthetically pleasing to the consumer's eye and touch for the foreseeable useful life of the container. Further, the labels 10 and 22 may be manufactured in a cost effective manner competitive in today's marketplace.

As an additional advantage the labels 10 and 22 accomplish these goals without using any offset powder. This aspect of the invention achieves a number of additional benefits. Specifically, in the absence of the offset powder the labels exhibit better color sharpness and an increase in gloss. Further by eliminating the use of offset powder, the label manufacturer and label applier no longer need to spend significant production downtime and employee labor cleaning offset powder from the label handling equipment as well as the electrical boxes and other areas of the workplace. Further, by eliminating offset powder from the environment, the workplace is made significantly cleaner and more worker-friendly.

A method of producing labels as illustrated in FIG. 1 from a printing stock in accordance with the present invention may, for example, be generally described as including the steps of: (a) printing a first face 14 of the printing stock 12 and (b) coating the first face and the second face 18 with an antistatic formulation.

A method of producing labels as illustrated in FIG. 2 from a printing stock may be generally described as including the steps of (a) printing a first face 26 of the printing stock 24 or a face of the clear polymer film 32, (b) laminating the clear polymer film 32 to the first face 26 of the printing stock and (c) coating the exposed faces of the label 22 with an antistatic formulation. Individual labels may be subsequently cut from the web to provide cut and stack labels.

More specifically describing the production method of the embodiment illustrated in FIG. 2, pre-press steps include making the printing plates, printing inks and selecting the printing stock.

The printing press steps include feeding the printing stock into the printing press. Specifically, as is known in the art, the printing press is composed of a feeding unit for feeding stock into the press, a number of print units and a delivery unit for delivering printed stock out of the press. Each print unit consists of (a) a number of printing cylinders for feeding the printing stock through the press, for applying ink to the printing plate and for transferring ink to the front face of the stock and/or the back side of the clear polymer film and (b) a drying and/or curing unit that dries the ink, coating or adhesive utilizing either hot air drying or ultraviolet curing.

At the first and each subsequent printing unit, ink of a particular color may be applied to the first or print face 26 of the printing stock 24 or the back side of the clear polymer film 32 utilizing the printing plate. Through the application of ink at each printing unit, the printed image of the label is created.

At the last printing unit, an ultraviolet activated adhesive is applied with a rubber roller to the first face 26 of the printing stock 24 over the printed image 28. The printing stock 24 is then nipped to a web of clear polymer film that is fed into the printing press for laminating to the printing stock. Following the nip, an ultraviolet lamp cures the ultraviolet adhesive through the clear film 32 while the printing stock 24 moves over a chilling roll to control the temperature of the stock.

The laminated web is then fed through an antistatic formulation applicator to provide a coating 34 of antistatic formulation over the upper or front face 36 and the lower or rear face 30 of the laminated web. The application may be made by a doctor blade system, a sprayer, a roller, a combination of the above or any other appropriate means. After application, the coating 34 is dried by forced gas drying, electric heat, forced air, a combination of the above or other appropriate means.

Next, the laminated printing stock is delivered, still in web form into a delivery unit. For cut and stack labels, the delivery unit cuts the stock into individual sheets with multiple labels 22 on each sheet. These sheets are then delivered onto a series of skids. Each skid of sheets moves to a post-press for final finishing of the label. Alternatively, the sheets could be fed directly into a finishing operation.

The post-press steps of the manufacturing process require each skid of sheets to be jogged, inspected, separated into specified increments of a desired number of sheets, cut, banded and packaged in a box. The sheets are jogged on a jogging machine that vibrates the sheets so that the sheets are aligned to each other for accurate cutting and counting.

After jogging, the specified lift of sheets is transferred via air tables to a cutting machine that cuts the sheets into bundles of individual labels 22. After the cutting machine, the bundle of individual labels 22, now in cut and stack form, are packaged and placed in a box for storage and shipment. A bundle of labels 22 can be packaged in a number of ways including banded, string tied or shrink wrapped.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, one side of the label could be coated with the antistat prior to laminating. The other side could then be coated with the antistat after laminating. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A label, comprising:
a sheet of printing stock having a first, printed face and a second opposite face; and
a coating of an antistatic formulation over said first, printed face and said second, opposite face.

2. The label of claim 1 wherein said antistatic formulation is applied at a rate of one pound of antistatic formulation to between about 480,000 square inches to about 900,000 square inches of said first, printed face and said second, opposite face and said label is devoid of an offset powder

3. The label of claim 1 wherein said printing stock is made from a material selected from a group consisting of polymer film, polypropylene, polyethylene, polystyrene, vinyl, polyethylene terephthalate, polyester, cavitated white BOPP, clear BOPP, saran polyethylene terephthalate, saran nylon cello, cello polypropylene, metalized polypropylene, cast polypropylene, metalized paper, metalized foil and mixtures thereof.

4. The label of claim 3, wherein said antistatic formulation comprises in weight percent from about 2.0% to about 6.0% antistatic agent, from about 0% to about 3.0% slip agent/wax, from about 0% to about 0.3% defoamer and the remainder solvent.

5. The label of claim 4, wherein said solvent is selected from a group consisting of alcohol, water and mixtures thereof.

6. The label of claim 1, wherein said antistatic formulation comprises in weight percent from about 2.0% to about 6.0% antistatic agent, from about 0% to about 3.0% slip agent/wax, from about 0% to about 0.3% defoamer and the remainder solvent.

7. The label of claim 6, wherein said solvent is selected from a group consisting of alcohol, water and mixtures thereof.

8. A label, comprising:
a first sheet of printing stock having a first, printed face and a second, opposite face;
a clear polymer film laminated to said first, printed face; and
a coating of an antistatic formulation over said second, opposite face and said clear polymer film.

9. The label of claim 8 wherein said antistatic formulation is applied at a rate of one pound of antistatic formulation to between about 480,000 square inches to about 900,000 square inches of said second, opposite face and said clear polymer film label is devoid of an offset powder.

10. The label of claim 8 wherein said printing stock is made from a material selected from a group consisting of polymer film, polypropylene, polyethylene, polystyrene, vinyl, polyethylene terephthalate, polyester, cavitated white BOPP, clear BOPP, saran polyethylene terephthalate, saran nylon cello, cello polypropylene, metalized polypropylene, cast polypropylene, metalized paper, metalized foil and mixtures thereof.

11. The label of claim 10, wherein said antistatic formulation comprises in weight percent from about 2.0% to about 6.0% antistatic agent, from about 0% to about 3.0% slip agent/wax, from about 0% to about 0.3% defoamer and the remainder solvent.

12. The label of claim 11, wherein said solvent is selected from a group consisting of alcohol, water and mixtures thereof.

13. The label of claim 8, wherein said antistatic formulation comprises in weight percent from about 2.0% to about 6.0% antistatic agent, from about 0% to about 3.0% slip agent/wax, from about 0% to about 0.3% defoamer and the remainder solvent.

14. The label of claim 13, wherein said solvent is selected from a group consisting of alcohol, water and mixtures thereof.

15. A label, comprising:
a first sheet of polymer film having a first face and a second face;
a second sheet of clear polymer film having a printed face and an opposite face, wherein said printed face is laminated to said first face; and
a coating of an antistatic formulation over said second face and said opposite face.

16. The label of claim 15 wherein said antistatic formulation is applied at a rate of one pound of antistatic formulation to between about 480,000 square inches to about 900,000 square inches of said second face and said opposite face and said clear polymer film label is devoid of an offset powder.

17. The label of claim 15 wherein said printing stock is made from a material selected from a group consisting of polymer film, polypropylene, polyethylene, polystyrene, vinyl, polyethylene terephthalate, polyester, cavitated white BOPP, clear BOPP, saran polyethylene terephthalate, saran nylon cello, cello polypropylene, metalized polypropylene, cast polypropylene, metalized paper, metalized foil and mixtures thereof.

18. The label of claim 17, wherein said antistatic formulation comprises in weight percent from about 2.0% to about 6.0% antistatic agent, from about 0% to about 3.0% slip agent/wax, from about 0% to about 0.3% defoamer and the remainder solvent.

19. The label of claim 18, wherein said solvent is selected from a group consisting of alcohol, water and mixtures thereof.

20. The label of claim 15, wherein said antistatic formulation comprises in weight percent from about 2.0% to about 6.0% antistatic agent, from about 0% to about 3.0% slip agent/wax, from about 0% to about 0.3% defoamer and the remainder solvent.

21. The label of claim 20, wherein said solvent is selected from a group consisting of alcohol, water and mixtures thereof.

22. A packaging material, comprising:
a sheet of polymer film having a first face and a second face both coated with an antistatic formulation.

23. A method of reducing maintenance costs associated with label handling equipment, comprising:
using labels coated on both faces with an antistatic formulation and devoid of offset powder.

24. A method of producing labels from a printing stock, comprising:
printing a first face of said printing stock; and
coating said first face and a second face of said printing stock with an antistatic formulation.

25. The method of claim 24 including making a smooth feeding label without using an offset powder.

26. A method of producing labels from a printing stock, comprising:
printing a first face of said printing stock;
laminating a clear polymer film to said first face of said printing stock over said printing; and
coating two exposed faces of said label with an antistatic formulation.

27. The method of claim 26 including making a smooth feeding label without using an offset powder.

28. A method of producing labels from a clear polymer film, comprising:
printing a first face of said clear polymer film;
laminating said first face of said clear polymer film to a face of a second layer of polymer film; and
coating two exposed faces of said label with an antistatic formulation.

29. The method of claim 28 including making a smooth feeding label without using an offset powder.
